(19) United States
(12) Patent Application Publication
(10) Pub. No.: US 2026/0187993 A1
(43) Pub. Date: Jul. 2, 2026

(54) GENERATING TRAINING INSTANCES FOR TRAINING GENERATIVE MODELS BASED ON CONTENT ITEMS

(71) Applicant: GOOGLE LLC, Mountain View, CA (US)

(72) Inventors: Ivor Rendulic, Thalwil (CH); Filip Pavetic, Zurich (CH); Manuel Tragut, Zug (CH)

(21) Appl. No.: 19/005,299

(22) Filed: Dec. 30, 2024

(51) Int. Cl. G06V 10/82; G06V 10/764; G06V 10/774; G06V 10/94; G06V 20/40; G06V 20/70

(52) U.S. Cl. CPC G06V 10/82; G06V 10/764; G06V 10/774; G06V 10/95; G06V 20/41; G06V 20/70

(57) ABSTRACT

Implementations disclosed herein relate to generating training instances for a generative model from a plurality of content items. A plurality of labels can be generated, each can be associated with a respective part of a content item. The labels can indicate whether a query is answerable based on information contained in the respective part of the content item. The parts of the content item, the query, and the plurality of labels, can then be provided as a training instance for training the generative model. Some of those implementations are further directed to utilizing the training instances to train the generative model to be able to generate, responsive to an input query and an input content item, generative output indicative of whether the input query is answerable based on at least part of the input content item.

### BACKGROUND

Various generative models have been proposed that can be used to process image content, audio content, natural language (NL) content and/or other input(s), to generate output that reflects generative content that is responsive to the input(s). As one example, large language models (LLM(s)) have been developed that can be used to process NL content and/or other input(s), such as streaming video, to generate LLM output that reflects NL content and/or other content that is responsive to the input(s). For instance, an LLM can be used to process multimedia content (e.g., audio and/or video content, such as streaming audio and/or video) together with a query relating to the video (e.g., in the form of NL content), to generate LLM output that reflects NL content responsive to the query.

However, current utilizations of generative models suffer from one or more drawbacks. For instance, a generative model may suffer from hallucination problems when processing queries relating to e.g. multimedia content, the multimedia content being provided to the model as input together with the query. For example, when a generative model is used to process a query that can only be answered based on information contained in the multimedia content (e.g., as opposed to queries that can potentially be answered based on a corpus of knowledge on which the generative model has been trained), the generative model can potentially generate responsive content containing false or misleading information. Such hallucinations can become more likely in scenarios where the multimedia content does not contain the information required to answer the query.

### SUMMARY

Implementations disclosed herein are directed to generating training instances for training generative models (e.g., LLMs) from a plurality of content items. A plurality of labels can be generated, each can be associated with a respective part of a content item. The labels can indicate whether a query is answerable based on information contained in the respective part of the content item. The parts of the content item, the query, and the plurality of labels, can then be provided as a training instance for training the generative model. Some of those implementations can be further directed to utilizing the training instances to train the generative model to be able to generate, responsive to an input query and an input content item, generative output indicative of whether the input query is answerable based on at least part of the input content item.

This approach can result in an improved generative model. For instance, when a generative model is trained based on a training instance comprising part of a content item, during training the generative model only has access to information contained in the part of the content item included in the training instance currently being processed, without having access to information in other parts of the content item. This can reduce the likelihood of hallucinations at inference time, by training the model to generate content responsive to the query based solely on information contained in the current part of a content item (e.g., the part of the content that is currently being processed by the generative model in an inference time environment).

In various implementations, the generative model can support bidirectional streaming, such that the output generated by the generative model can be updated whilst continuing to receive new streaming content. By generating training instances using methods such as those disclosed herein, the generative model can be trained to generate output responsive to a query that is indicative of whether or not the query can be answered based on information contained in the content currently being processed (e.g., in an inference time environment). For example, in some implementations the training instances can be utilized to train a generative model to generate generative output that indicates whether the input query can be answered. In some of those implementations, further streaming may be ceased (e.g., a user may stop providing the streaming video to the generative model) in dependence on the generative output indicating that the query can be answered.

Accordingly, implementations can conserve system resources (e.g., bandwidth, memory, processor runtime etc.) by avoiding a situation in which streaming content continues to be inputted to the generative model even after a query has been answered. As a further benefit, in some implementations a user may utilize the generative model to process streaming content and automatically generate an answer to a query, without having to view the content themselves, thereby requiring less time and effort on the user's part and potentially reducing the time taken to find an answer to the query.

As described herein, a generative model (GM) can be any sequence-to-sequence based machine learning model capable of generating generative vision data, generative audio data, generative textual data, and/or other forms of generative data. Some non-limiting examples of sequence-to-sequence based machine learning models that are capable of generating one or more forms of the generative data noted above include transformer-based machine learning models (e.g., encoder-decoder transformer models, encoder-only transformer models, decoder-only transformer models, etc. that optionally employ an attention mechanism or some other form of memory), stable diffusion-based machine learning models, recurrent neural network-based machine learning models, generative adversarial network-based machine learning models, etc. Various sequence-to-sequence based machine learning models have demonstrated multimodal capabilities in that they are capable of processing inputs in various modalities (e.g., text-based inputs, vision-based inputs, audio-based inputs, etc.) and generating outputs in various modalities (e.g., text-based output, vision-based outputs, audio-based generative outputs, etc.). Some particular non-limiting examples of these sequence-to-sequence based machine learning models that have demonstrated multimodal capabilities include the Gemini family of models, the ChatGPT family of models, the Claude family of models, the Llama family of models, and/or other families of sequence-to-sequence generative models.

The preceding is presented as an overview of only some implementations disclosed herein. These and other implementations are disclosed in additional detail herein.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 depicts a flowchart that illustrates an example method of generating training instances for training a generative model to process queries relating to content items, in accordance with various implementations.

FIG. 3 depicts an example of a plurality of frames from a video.

FIG. 4 depicts an example architecture of a computing device, in accordance with various implementations.

### DETAILED DESCRIPTION

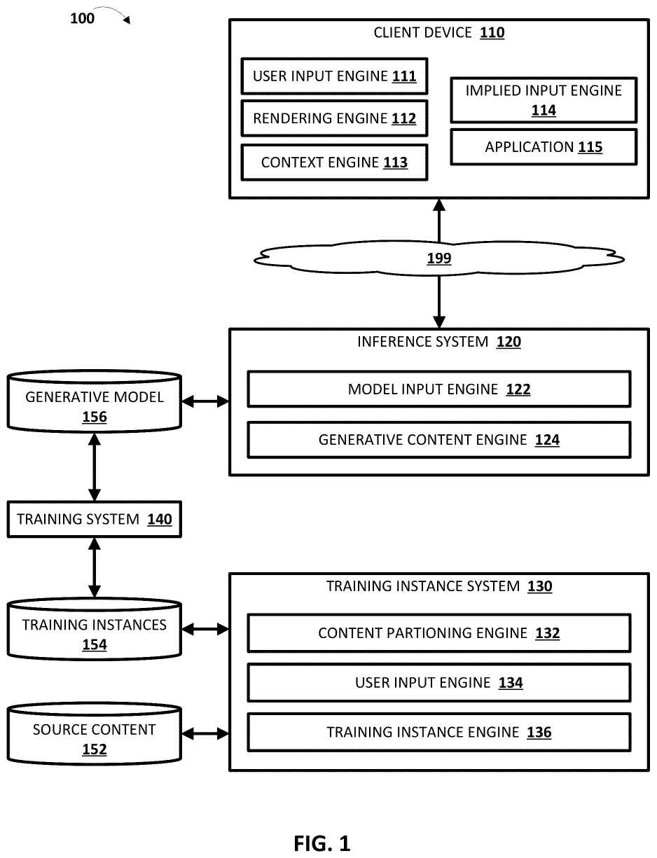

Turning now to FIG. 1, a block diagram of an example environment 100 that demonstrates various aspects of the present disclosure, and in which implementations disclosed herein can be implemented is depicted. The example environment 100 includes a client device 110, an inference system 120, a training instance system 130, and a training system 140. The example environment 100 further includes a source videos database 152 that is utilized by the training instance system 130 in generating training instances 154. The example environment 100 further includes a generative model 156 (e.g., an LLM) that is trained, by the training system 140, utilizing the training instances 154.

Although illustrated separately, in some implementations all or aspects of inference system 120, training instance system 130, and/or training system 140 can be implemented as part of a cohesive system. For example, the same entity can be in control of the inference system 120, the training instance system 130, and the training system 140, and implement them cohesively. However, in some implementations one or more of the system(s) can be controlled by separate parties. In some of those implementations, one party can interface with system(s) of another party utilizing, for example, application programming interface(s) (API(s)) of such system(s).

In some implementations, all or aspects of the inference system 120 can be implemented locally at the client device 110. In additional or alternative implementations, all or aspects of the inference system 120 can be implemented remotely from the client device 110 as depicted in FIG. 1 (e.g., at remote server(s)). In those implementations, the client device 110 and the inference system 120 can be communicatively coupled with each other via one or more networks 199, such as one or more wired or wireless local area networks (“LANs,” including Wi-Fi LANs, mesh networks, Bluetooth, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more applications, such as application 115, via which queries, that are included in requests, can be submitted and/or via which responses generated by generative model(s) (e.g., NMT model(s) and/or LLM(s)) and/or other response(s) to the requests can be rendered (e.g., audibly and/or visually). The application 115 can be an application that is separate from an operating system of the client device 110 (e.g., one installed “on top” of the operating system) - or can alternatively be implemented directly by the operating system of the client device 110. For example, the application 115 can be a web browser installed on top of the operating system, or can be an application that is integrated as part of the operating system functionality. The application 115 can interact with the inference system 120.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to touch input directed to the client device 110. Some instances of new source input described herein, that can be received in an inference time environment, can be source input that is formulated based on user input provided by a user of the client device 110 and detected via user input engine 111. For example, the new source input can be a typed input that is typed via a physical or virtual keyboard, a suggested input that is selected via a touch screen or a mouse, a spoken voice input that is detected via microphone(s) of the client device 110, or an image input that is based on an image captured by a vision component of the client device 110 (e.g., NL text determined from OCR processing of the image).

In various implementations, the client device 110 can include a rendering engine 112 that is configured to provide content (e.g., a natural language based response generated by an NMT model or an LLM) for audible and/or visual presentation to a user of the client device 110 using one or more user interface output devices. For example, the client device 110 can be equipped with one or more speakers that enable content to be provided for audible presentation to the user via the client device 110. Additionally, or alternatively, the client device 110 can be equipped with a display or projector that enables content to be provided for visual presentation to the user via the client device 110.

In various implementations, the client device 110 can include a context engine 113 that is configured to determine a context (e.g., current or recent context) of the client device 110 and/or of a user of the client device 110. In some of those implementations, the context engine 113 can determine a context utilizing current or recent interaction(s) via the client device 110, a location of the client device 110, profile data of a profile of a user of the client device 110 (e.g., an active user when multiple profiles are associated with the client device 110), and/or other data accessible to the context engine 113. For example, the context engine 113 can determine a current context based on a current state of a query session (e.g., considering one or more recent queries of the query session), profile data, and/or a current location of the client device 110. For instance, the context engine 113 can determine a current context of “looking for a healthy lunch restaurant in Louisville, Kentucky” based on a recently issued query, profile data, and a location of the client device 110. As another example, the context engine 113 can determine a current context based on which application is active in the foreground of the client device 110, a current or recent state of the active application, and/or content currently or recently rendered by the active application. A context determined by the context engine 113 can be utilized, for example, in supplementing or rewriting user input (e.g., the supplemented or rewritten version can be that processed by a generative model in the inference environment), in generating an implied query (e.g., a query formulated independent of user input), and/or in determining to submit an implied query and/or to render result(s) (e.g., a NMT model generated response or LLM generated response) for an implied query.

In various implementations, the client device 110 can include an implied input engine 114 that is configured to: generate an implied source input independent of any user input directed to formulating the implied source input; to submit a request that includes the implied source input, optionally independent of any user input that requests submission of the request; and/or to cause rendering of a response for an implied source input, optionally independent of any user input that requests rendering of the response. For example, the implied input engine 114 can use current context, from current context engine 113, in generating an implied source input, determining to submit a request that includes the implied source input, and/or in determining to cause rendering of a response for the implied source input. For instance, the implied input engine 114 can automatically generate and automatically submit an implied source input based on the current context. Further, the implied input engine 114 can automatically push a response, to the implied source input, to cause the response to be automatically rendered or can automatically push a notification of the response, such as a selectable notification that, when selected, causes rendering of the response. As another example, the implied input engine 114 can generate an implied source input based on profile data (e.g., an implied query related to an interest of a user), submit the query at regular or non-regular intervals, and cause a corresponding response to be automatically provided (or a notification thereof automatically provided).

Further, the client device 110, the inference system 120, the training instance system 130, and/or the training system 140 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device 110 having a single user, it should be understood that such illustration is for the sake of example and is not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household).

Generally, training instance system 130 generates training instances 154 that are used by training system 140 to train a generative model, resulting in a trained generative model 156. The inference system 120 utilizes the trained generative model 156 in an inference time environment in generating generative content predictions to provide responsive to requests from the client device 110 and/or from other computing device(s). As described in detail herein, the training instances 154 that are generated by the training instance system 130 can be used to train the generative model 156 to process queries relating to video content (e.g., queries relating to one or more events that occur in a video). After being trained based on the training instances 154 generated by the training instance system 130, the trained generative model 156 can generate, responsive to a query and a video (e.g., received from the client device 110 and/or from other computing device(s)), generative output indicative of whether the query is answerable based on at least part of the video.

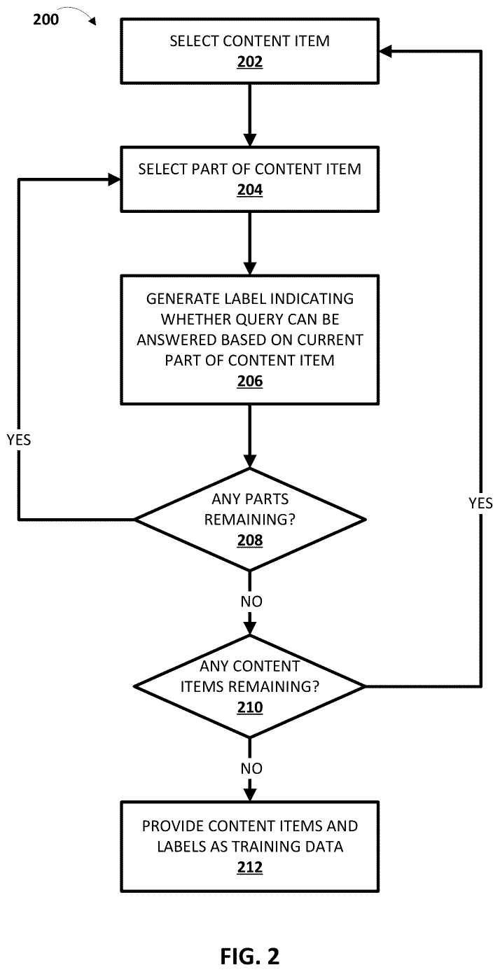

Training instance system 130 is illustrated as including a content partitioning engine 132, a user input engine 134, and a training instance engine 136. In various implementations, training instance system 130 can perform all or aspects of blocks 202 to 212 of FIG. 2, as described in more detail herein.

In generating a training instance, the training instance engine 136 can select a source content item (e.g., a video) from source content database 152. The content partitioning engine 132 can partition the selected source content item into a plurality of parts. In some implementations, the content item selected by the training instance engine 136 can include video, and each one of the plurality of parts of the content item partitioned by the content partitioning engine 132 can include a plurality of frames of video. For instance, each part of the content item can include a sequence of consecutive frames of the video (e.g., a video clip extracted from the content item). Purely as an illustrative example, without limitation, in some implementations the content partitioning engine 132 can partition a content item including video into a plurality of video clips of predefined lengths (e.g., 4 seconds). In other implementations, each one of the plurality of parts of a content item including video can include a respective frame of the video (e.g., a single frame). In still other implementations, the content partitioning engine 132 can partition the content item into a plurality of parts with different formats. For instance, for a content item including video, some parts of the content item partitioned by the content partitioning engine 132 can include a plurality of frames, whilst other parts can include a single frame.

In some implementations, consecutive ones of the plurality of parts can be spaced apart in time in the content item, such that the plurality of parts comprise discontinuous parts of the original content item. In some of those implementations, for a content item including video, some or all of the plurality of parts can include respective frames of the video, such that the frame of one part of the video is separated from respective frames of other parts of the video by one or more other frames of the video (e.g., other frames that are not included in any of the plurality of parts). Purely as an illustrative example, without limitation, in some implementations the content partitioning engine 132 can partition a content item including video into a plurality of parts each including a single frame, with consecutive parts being spaced apart in time by a fixed interval (e.g., 1 second) in the original content item. In other implementations, the plurality of parts can collectively include the whole of the video from the content item (e.g., a content item that has been partitioned by the content item partitioning engine 132).

In generating the training instance, the training instance engine 136 can store, as a training instance of the training instances 154, each part of a selected one of the source content items (e.g., each part of a selected source content item partitioned by the content partitioning engine 132) along with an associated label indicating whether a respective query is answerable based on information contained in the part of the content item. In this way, the stored parts of source content items and their associated labels can be provided as training instances for training the generative model 156 by the training system 140. The training instance system 130 can generate multiple training instances 154, with each being generated based on a different source content item of the source content database 152.

In various implementations, the training instance system 130 can include a user input engine 134 that is configured to detect user input provided by a user of the training instance system 130 using one or more user interface input devices. For example, the user input engine 134 of the training instance system 130 can be equipped with one or more microphones that capture audio data, such as audio data corresponding to spoken utterances of the user or other sounds in an environment of the user input engine 134. Additionally, or alternatively, the user input engine 134 of the training instance system 130 can be equipped with one or more vision components that are configured to capture vision data corresponding to images and/or movements (e.g., gestures) detected in a field of view of one or more of the vision components. Additionally, or alternatively, the training instance system 130 can be equipped with one or more touch sensitive components (e.g., a keyboard and mouse, a stylus, a touch screen, a touch panel, one or more hardware buttons, etc.) that are configured to capture signal(s) corresponding to touch input directed to the training instance system 130.

Some instances of labels associated with parts of content items described herein, that are indicative of whether a respective query is answerable based on information contained in the respective part of the content item, can be source input that is formulated based on user input provided by a user of the training instance system 130 and detected via the user input engine 134 of the training instance system 130. For example, the source input (e.g., a label to be associated with a part of a content item currently being processed by the training instance engine 136) can be a typed input that is typed via a physical or virtual keyboard, a suggested input that is selected via a touch screen or a mouse, a spoken voice input that is detected via microphone(s) of the training instance system 130, or an image input that is based on an image captured by a vision component of the training instance system 130 (e.g., NL text determined from OCR processing of the image). In some implementations, the label(s) associated with one or more parts of a content item can be generated automatically (e.g., via a suitably-trained generative model), instead of or in addition to labels being generated based on user input.

In some implementations, the training instance engine 136 can provide a training instance by storing the complete content item together with the labels associated with respective parts of the content item. In other implementations, the training instance engine 136 can provide the training instances 154 by storing the plurality of parts (e.g., discontinuous parts of the content item partitioned by the content partitioning engine 132) together with the labels associated with respective parts of the content item. By only storing a plurality of discontinuous parts of a content item, as opposed to storing the complete content item, the resources (e.g., memory capacity) required to store and/or subsequently process the training instances 154 can be reduced.

In some implementations, the training instance engine 136 can provide each part of a content item, together with the associated label indicating whether a respective query is answerable based on information contained in the part of the content item, as a separate training instance 154. By utilizing each part of a content item as a separate training instance 154, the generative model 156 can be trained by the training system 140 to generate generative content responsive to an input query that more accurately represents whether the query can be answered based on information contained in part of an input content item (e.g., a part of a new content item provided to the generative model 156 as input together with the query).

For instance, the accuracy of the generative model 156 can be improved since when the generative model 156 is being trained by the training system 140 based on a training instance comprising a single part of a content item, the generative model 156 only has access to information contained in the part of the content item included in the training instance currently being processed, without having access to information in other parts of the content item. This approach can reduce the likelihood of hallucinations at inference time.

In training the generative model 156 based on one of the training instances 154, the training system 140 can select one of the training instances 154, process source input (e.g., a part of a content item and a query) of the selected training instance using the generative model 156 as currently trained to generate generative model output, and generate a loss based on comparing that generative model output to the associated label(s) indicating whether the query can be answered based on information contained in the respective part of the content item. The training system 140 can then update the generative model 156 based on the loss and, optionally, based on additional similarly determined loss(es) in batch training implementations. The training system 140 can fine-tune the generative model 156 based on multiple (e.g., all of) the training instances 154.

Inference system 120 is illustrated as including a model input engine 122 and a generative content engine 124.

The model input engine 122 can, in response to receiving a query/input data, generate model input that is to be processed using the generative model 156 in generating a response to the query/input data. As described herein, such content can include query content that is based on the query and/or additional content, such as contextual information. The model input engine 122 can, for example, reformat input data into a suitable form for input into the generative model 156, e.g., reformat an input NL query as a prompt for an LLM, reformat one or more input images into a tensor for input into the image generation model 156 or the like.

In generating generative content to provide responsive to a request from the client device 110 and/or from other computing device(s), the generative content engine 124 can process an input, of the request, using the generative model 156, to generate generative model output. For example, the generative model output can include a sequence of probability distributions.

In various implementations, the generative model 156 can be a multimodal generative model configured to process input in a plurality of formats. For instance, in some of those implementations, the plurality of formats include one or more video formats and/or one or more audio formats. The plurality of content items can include video and/or audio content, as appropriate depending on the format(s) capable of being processed by the generative model 156.

In various implementations, the generative content engine 124 can process input data that is generated by the model input engine 122 (e.g., using the generative model 156) to generate response/output data. The generative content engine 122 can generate one or more candidate responses from the input data/query using one or more generative models 156. Generating the one or more generative outputs from a respective set of input data can include generating one or more distributions over a set of potential generative outputs. Each generative output may be generated by sampling from this distribution, e.g., each generative output may correspond to a different decoding of a probability distribution generated using the respective model. In some implementations, a response selection engine (not shown) can select one or more of the candidate responses generated by the generative content engine 124 for presentation to the user, e.g., via the rendering engine 112 and/or application 115 of the client device 110.

The generative content engine 124 can cause the generated content prediction to be provided responsive to the request. For example, when the request is from the client device 110, the generative content engine 124 can cause the generated content prediction to be visibly and/or audible rendered by the rendering engine 112 of the client device 110. For instance, the generative content engine 124 can transmit data, to the client device 110, that is operable to cause the rendering engine 112 to render the generated content prediction. As another example, when the inference system 120 is implemented in cloud-based server(s) and the request is from other cloud-based server(s), the generative content engine 124 can cause the generated content prediction to be transmitted to the other cloud-based server(s) responsive to the request (e.g., along with an indication of the request to which the generated content prediction is responsive).

In some implementations, the generative model 156 supports bidirectional streaming. When bidirectional streaming is supported, the generative model 156 can generate new generative content (e.g., to update or replace previously-generated content) while simultaneously receiving (e.g., continuing to receive) streaming input (e.g., streaming video and/or audio content).

For instance, in some implementations where bidirectional streaming is supported, the generative model 156 can be utilized to process input comprising streaming content (e.g., video and/or audio) and a query relating to one or more events that may (or may not) occur in the streaming content. In some such implementations, the generative model 156 can be trained to generate new generative output responsive to the event(s) occurring in the input streaming content. In this way, the generative content engine 124 can utilize the generative model 156 to generate first generative content indicating that the query cannot be answered (e.g., cannot yet be answered) based on information contained in the input streaming content up to the present point in time. Then, responsive to the event(s) occurring in the streaming content, the generative content engine 124 can utilize the generative model 156 to generate second generative content indicating that the query can be answered. The second generative content may include an answer to the query. In this way, an answer to a query can be updated as and when an event that is relevant to the query occurs in the input streaming content.

Turning now to FIG. 2, a flowchart illustrating an example method 200 of generating training instances for training a generative model to process queries relating to content items (e.g., media or multimedia content items, such as video and/or audio content) is depicted, in accordance with various implementations.

At block 202, the system selects a content item. For instance, the content item selected in block 202 can be one of a plurality of content items stored in the source content database 152. Block 202 can include selection of the content item by the training instance engine 136.

At block 204, the system selects a part of the content item (e.g., the content item selected in block 202). The selection of part of a content item in block 204 can be made by the training instance engine 136, following partitioning of the selected content item by the content partitioning engine 132. In some implementations, instead of the content partitioning engine 132 partitioning a content item, part(s) of the content item can be obtained in a different manner. For instance, in some implementations the part(s) of a content item can be user-defined, for example by a user selecting individual frames of video and/or defining start or end points of a part of the content item.

At block 206, the system generates a respective label each associated with the currently-selected part of the content item. The label indicates whether a respective query is answerable based on information contained in the currently-selected part of the content item. For instance, the label can be generated in dependence on user input received via the user input engine 134 of the training instance system (e.g., the label can be user-defined).

In some implementations, the label generated in block 206 can take one of a plurality of values, including a first value indicating that the query cannot be answered based on information contained in the currently-selected part of the content item, and a second value indicating that the query can be answered based on information contained in the currently-selected part of the content item. In some implementations, the plurality of values includes a third value indicating that the query cannot be answered based on information contained in the currently-selected part of the content item, but can potentially be answerable based on information contained in another one of the plurality of parts of the content item.

In some implementations, the system can generate contextual information indicative of an event occurring in the currently-selected part of the content item. The contextual information can be generated before or after block 206, or concurrently with block 206. For instance, the event to which the contextual information relates can be the same event to which the query relates. In implementations that generate contextual information, the contextual information can be included in the training instance to assist in training the generative model 156.

At block 208, the system determines whether any parts of the content item remain to be processed (e.g., whether a label has yet to be generated for any remaining parts of the content item). If so, the system proceeds back to block 204 and selects another part of the content item (e.g., the next part in a sequence of parts). If not, the system proceeds to block 210.

At block 210, the system determines whether any content items remain to be processed (e.g., whether any content items stored in the source content database 152 have yet to be processed by the training instance engine 136). If so, the system proceeds back to block 202 and selects another content item. If not, the system proceeds to block 212. In some implementations, the system can be configured to generate training instances from all content items stored in the source content database 152. In other implementations, the system can be configured to only generate training instances from some of the content items (e.g., a predefined number of content items) stored in the source content database 152.

At block 212, the system provides, for each of the plurality of content items processed in blocks 202 to 210, at least the plurality of parts of the content item, the respective query and the plurality of labels, as a training instance for training the generative model 156.

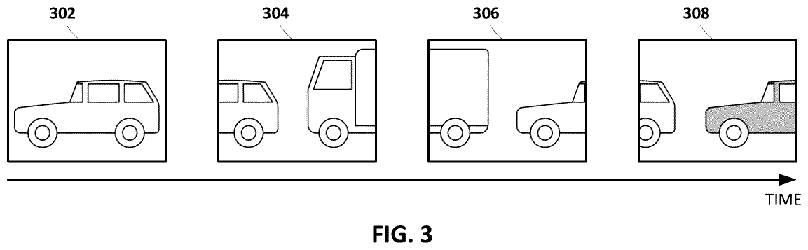

Turning now to FIG. 3, a plurality of frames from a video are depicted by way of an illustrative example. The video frames illustrated in FIG. 3 can be an example of a content item stored by the source content database 152, from which a training instance can be generated by the training instance system 130. In the example illustrated in FIG. 3, the video depicts a plurality of vehicles following one after the other. In any given frame of the video, some, all or none of the vehicles may be visible.

Purely by way of an illustrative example, a query relating to the video can be the question “What vehicle is following the truck?”. When generating a training instance based on the video depicted in FIG. 3, labels generated for the first frame 302, the second frame 304 and the fourth frame 308 illustrated in FIG. 3 can indicate that query cannot be answered based on information contained in the respective part (e.g., the first, second or fourth frames 302, 304, 308) of the content item. In contrast, the label generated for the third frame 306 can indicate that the query can be answered based on the information contained in the respective part (e.g., the third frame 306) of the content item. For instance, based on information contained in the third frame 306 the query can be answered as “A white car is following the truck”.

In some implementations, the generative model 156 can be trained to generate updated generative content responsive to an event occurring in the input content (e.g. streaming video and/or audio). Turning now to an example in which the inference system 120 utilizes the generative model 156 at inference time to generate a response to the input query “What vehicle is following the truck?”, the input further including streaming video with content as shown in FIG. 3, responsive to processing the first frame 302 together with the input query the generative model 156 can decode the generative output “I don't see a truck”. Subsequently, responsive to processing the second frame 304 together with the input query, the generative model 156 can decode the generative output “Oh wait, I can see a truck but can't see what is behind it”. Then, responsive to processing the third frame 306 together with the input query the generative model 156 can decode the generative output “A white car is following the truck”. In this way, each time a new part of the content (e.g., streaming content) is processed by the generative model 156, the generative output can be updated to reflect whether or not the input query can be answered based on information in the part of content currently being processed.

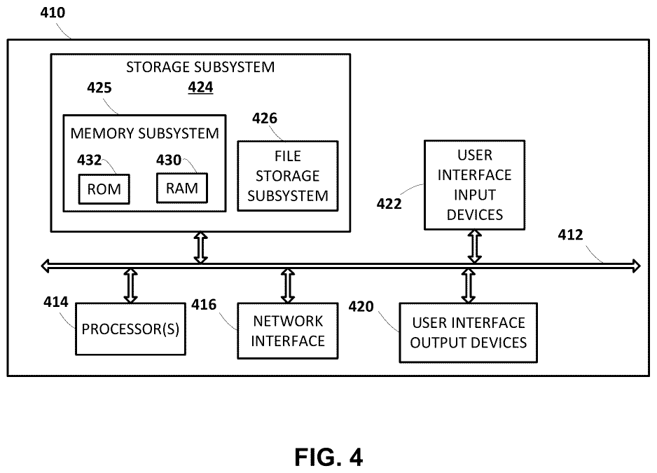

Turning now to FIG. 4, a block diagram of an example computing device 410 that may optionally be utilized to perform one or more aspects of techniques described herein is depicted. In some implementations, one or more of a client device, cloud-based automated assistant component(s), and/or other component(s) may comprise one or more components of the example computing device 410.

Computing device 410 typically includes at least one processor 414 which communicates with a number of peripheral devices via bus subsystem 412. These peripheral devices may include a storage subsystem 424, including, for example, a memory subsystem 425 and a file storage subsystem 426, user interface output devices 420, user interface input devices 422, and a network interface subsystem 416. The input and output devices allow user interaction with computing device 410. Network interface subsystem 416 provides an interface to outside networks and is coupled to corresponding interface devices in other computing devices.

User interface input devices 422 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 410 or onto a communication network.

User interface output devices 420 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 410 to the user or to another machine or computing device.

Storage subsystem 424 stores programming and data constructs that provide the functionality of some, or all, of the modules described herein. For example, the storage subsystem 424 may include the logic to perform selected aspects of the methods disclosed herein, as well as to implement various components depicted in FIG. 1.

These software modules are generally executed by processor 414 alone or in combination with other processors. Memory 425 used in the storage subsystem 424 can include a number of memories including a main random-access memory (RAM) 430 for storage of instructions and data during program execution and a read only memory (ROM) 432 in which fixed instructions are stored. A file storage subsystem 426 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 426 in the storage subsystem 424, or in other machines accessible by the processor(s) 414.

Bus subsystem 412 provides a mechanism for letting the various components and subsystems of computing device 410 communicate with each other as intended. Although bus subsystem 412 is shown schematically as a single bus, alternative implementations of the bus subsystem 412 may use multiple busses.

Computing device 410 can be of varying types including a workstation, server, computing cluster, blade server, server farm, or any other data processing system or computing device. Due to the ever-changing nature of computers and networks, the description of computing device 410 depicted in FIG. 4 is intended only as a specific example for purposes of illustrating some implementations. Many other configurations of computing device 410 are possible having more or fewer components than the computing device depicted in FIG. 4.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided and includes, for each of a plurality of content items, generating a respective plurality of labels each associated with one of a plurality of parts of said content item, each said label indicating whether a respective query is answerable based on information contained in said part of the content item; and for each of the plurality of content items, providing at least the plurality of parts of the content item, the respective query and the plurality of labels, as a training instance for training a generative model.

These and other implementations of the technology disclosed herein can include one or more of the following features.

In some implementations, each said label can take one of a plurality of values, the plurality of values can include: a first value indicating that the query cannot be answered based on said information contained in the respective part of said content item; and a second value indicating that the query can be answered based on said information contained in the respective part of said content item.

In some implementations, the plurality of values can include a third value indicating that the query cannot be answered based on said information contained in the respective part of said content item, but can potentially be answerable based on information contained in another one of the plurality of parts of said content item.

In some implementations, at least one of the plurality of content items can include a video, and each one of the plurality of parts of said video can include a plurality of frames of video.

In some implementations, at least one of the plurality of content items can include a video, and each one of the plurality of parts of said video can include a respective frame of said video.

In some implementations, consecutive ones of the plurality of parts can be spaced apart in time in said video, such that each said respective frame is separated from respective frames of other ones of the plurality of parts by one or more other frames of said video.

In some implementations, providing at least the plurality of parts of the content item as the training instance can include providing the complete content item.

In some implementations, consecutive ones of the plurality of parts can be spaced apart in time in said content item, such that the plurality of parts can include discontinuous parts of said content item, and providing at least the plurality of parts of the content item as the training instance can include providing said discontinuous parts of said content item.

In some implementations, for one or more of the plurality of content items the method can include: for one or more of the plurality of parts of said one or more of the plurality of content items, generating contextual information indicative of an event occurring in said part of said content item. In some of those implementations, the query can relate to said event.

In some implementations, the method can include: using said training instance, training the generative model to be able to generate, responsive to an input query and an input content item, generative output indicative of whether the input query is answerable based on at least part of the input content item.

In some implementations, training the generative model can include:
training the generative model to be able to update the generative output responsive to the generative model processing a part of the input content item containing information that enables the input query to be answered.

In some implementations, the generative model can be a large language model (LLM).

In some implementations, the generative model can be a multimodal generative model configured to process input in a plurality of formats. In some of those implementations, the plurality of formats can include one or more video formats and/or one or more audio formats. In some of those implementations, the plurality of content items can include video and/or audio content.

In some implementations, the generative model can support bidirectional streaming.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more transitory or non-transitory computer readable storage media storing computer instructions executable by one or more processors to perform any of the aforementioned methods. Some implementations also include a computer program product including instructions executable by one or more processors to perform any of the aforementioned methods.

What is claimed is:

1. A method implemented by one or more processors, the method comprising:
for each of a plurality of content items, generating a respective plurality of labels each associated with one of a plurality of parts of said content item, each said label indicating whether a respective query is answerable based on information contained in said part of the content item; and
for each of the plurality of content items, providing at least the plurality of parts of the content item, the respective query and the plurality of labels, as a training instance for training a generative model.

2. The method of claim 1, wherein each said label takes one of a plurality of values, the plurality of values comprising:
a first value indicating that the query cannot be answered based on said information contained in the respective part of said content item; and
a second value indicating that the query can be answered based on said information contained in the respective part of said content item.

3. The method of claim 2, wherein the plurality of values comprises:
a third value indicating that the query cannot be answered based on said information contained in the respective part of said content item, but can potentially be answerable based on information contained in another one of the plurality of parts of said content item.

4. The method of claim 1, wherein at least one of the plurality of content items comprises a video, each one of the plurality of parts of said video comprising a plurality of frames of video.

5. The method of claim 1, wherein at least one of the plurality of content items comprises a video, each one of the plurality of parts of said video comprising a respective frame of said video.

6. The method of claim 5, wherein consecutive ones of the plurality of parts are spaced apart in time in said video, such that each said respective frame is separated from respective frames of other ones of the plurality of parts by one or more other frames of said video.

7. The method of claim 1, wherein providing at least the plurality of parts of the content item as the training instance comprises providing the complete content item.

8. The method of claim 1, wherein consecutive ones of the plurality of parts are spaced apart in time in said content item, such that the plurality of parts comprise discontinuous parts of said content item, and
wherein providing at least the plurality of parts of the content item as the training instance comprises providing said discontinuous parts of said content item.

9. The method of claim 1, wherein for one or more of the plurality of content items the method comprises:
for one or more of the plurality of parts of said one or more of the plurality of content items, generating contextual information indicative of an event occurring in said part of said content item.

10. The method of claim 9, wherein the query relates to said event.

11. The method of claim 1, further comprising:
using said training instance, training the generative model to be able to generate, responsive to an input query and an input content item, generative output indicative of whether the input query is answerable based on at least part of the input content item.

12. The method of claim 11, wherein training the generative model comprises:
training the generative model to be able to update the generative output responsive to the generative model processing a part of the input content item containing information that enables the input query to be answered.

13. The method of claim 1, wherein the generative model is a large language model (LLM).

14. The method of claim 1, wherein the generative model is a multimodal generative model configured to process input in a plurality of formats.

15. The method of claim 14, wherein the plurality of formats comprise one or more video formats and/or one or more audio formats.

16. The method of claim 14, wherein the plurality of content items comprise video and/or audio content.

17. The method of claim 1, wherein the generative model supports bidirectional streaming.

18. A system comprising:
one or more processors; and
memory storing computer readable instructions that, when executed by the one or more processors, cause the one or more processor to be operable to:
for each of a plurality of content items, generate a respective plurality of labels each associated with one of a plurality of parts of said content item, each said label indicating whether a respective query is answerable based on information contained in said part of the content item; and
for each of the plurality of content items, provide at least the plurality of parts of the content item, the respective query and the plurality of labels, as a training instance for training a generative model.

19. A non-transitory computer readable medium containing computer-readable instructions that, when executed by a computer, cause the computer to:
for each of a plurality of content items, generate a respective plurality of labels each associated with one of a plurality of parts of said content item, each said label indicating whether a respective query is answerable based on information contained in said part of the content item; and
for each of the plurality of content items, provide at least the plurality of parts of the content item, the respective query and the plurality of labels, as a training instance for training a generative model.
